(19) United States
(12) Patent Application Publication
(10) Pub. No.: US 2017/0243303 A1
(43) Pub. Date: Aug. 24, 2017

(54) SOCIAL MEDIA ANALYTICS AND RESPONSE

(71) Applicant: HEWLETT PACKARD ENTERPRISE DEVELOPMENT LP, Houston, TX (US)

(72) Inventors: Sunil DODDMANI MANJUNATH, Bangalore (IN); Hari KRISHNAMRAJU SAGIRAJU, Bangalore (IN); Myran DASILVA, Bangalore (IN)

(73) Assignee: HEWLETT PACKARD ENTERPRISE DEVELOPMENT LP, Houston, TX (US)

(21) Appl. No.: 15/317,694

(22) PCT Filed: Nov. 3, 2014
(86) PCT No.: PCT/IN2014/000707

§ 371 Date: Dec. 9, 2016

(51) Int. Cl. G06Q 50/00; G06Q 30/00

(52) U.S. Cl. CPC G06Q 50/01; G06Q 30/016; G06Q 30/0281

(57) ABSTRACT

An example social media analytics and response method includes analyzing an event on a social media platform. The method also includes interfacing with customer support to handle the event. The method also includes automatically issuing a response on the social media platform including at least a status of the event.

### BACKGROUND

Nearly every product released to market is met by at least a few unhappy customers, for example, due to issues with the product itself and/or unmet expectations of the customer. While the company behind the product may offer customer support, these channels are typically one-on-one and can result in a delayed response to the broader marketplace. Indeed, in fast-paced industries, such as the electronics and software industry, by the time the company identifies issues logged by customer support, a new product may have already been released. This same approach to issue identification can also affect service-based businesses.

### BRIEF DESCRIPTION OF THE DRAWINGS

FIG. 1 is a high-level illustration of an example networked computer system which may implement social media analytics and response.

FIGS. 2A-C show example architectures of computer-readable instructions illustrating social media analytics and response.

FIG. 3 illustrates interaction with a user in a social media interface according to an example of social media analytics and response.

FIG. 4 is a process flow diagram illustrating an example Stage 1 social media analytics and response.

FIG. 5 is a process flow diagram illustrating an example Stage 2 social media analytics and response.

FIGS. 6-8 are flowcharts illustrating example operations which may be implemented for social media analytics and response.

### DETAILED DESCRIPTION

Social media can be generally defined as electronic communication networks (e.g., Internet-based and private networks) where ideas, messages and other information and content (e.g., videos) are shared in online communities. Social media is currently believed to reach every one in four people worldwide, and is one of the fastest growing sources of online content. Social media has brought the power of word-of-mouth advertising to a large audience. Social media has also brought the power to individuals to vent their frustrations with products, services, and customer support for those products and services. Effectively responding to customers through social media is thus increasingly important to influence customer sentiment, and hence drive future sales.

Often, the first place customers publish feedback (both positive and negative) about their purchase is on popular social media sites, such as Twitter® and Facebook®. If the customer is experiencing trouble with a purchase, many times the customer will take to social media before even taking their complaint to customer support. Customers may post their frustrations on their own personal social media “page” or on the company's official social media “page.”

Failing to address customer frustrations in a timely and constructive manner may perpetuate the feelings of frustration experienced by the customer. A wait-and-see approach to issue identification is ineffective and can lead to greater customer dissatisfaction with a consumable, and even the company as a whole. Ineffective resolution of issues may lead to a bad reputation and even total collapse of the offering in the marketplace.

Social media posts often result in a large amount of data (e.g., terabytes of social media data). The techniques described herein process this data by evaluating the posts to social media for user sentiment (e.g., negative sentiment). In an example, customer support agents' social media accounts are monitored to assess interaction with the social media users. A runtime library (RTL) may be implemented to extract data from social media sites of interest, and derive sentiment from posts to these social media sites (e.g., using Hewlett Packard's Vertica™ Pulse). User data (e.g., posts, comments, “tweets”) having a negative sentiment is captured and responded to in an effective manner to build confidence in customer support.

In an example, data gathered from social media sites is shared with customer support. Customer support agents responsible for responding to customers on social media on their issues receive an organized workflow, helping to ensure that all issues are addressed in a timely and effective manner, and that the customer is notified on the result.

A social media analytics and response method is disclosed. An example method includes analyzing an event on a social media platform, such as a user post about a product or service being monitored. Analyzing the event may include extracting user sentiment from the event, e.g., to identify negative sentiment in a user post.

The example method also includes interfacing with customer support to handle the event. For example, information such as at least one parameter may be extracted from the event and issued to the customer support. The parameter and/or other information may be issued to the customer support in any of a plurality of selectable data formats (e.g., as JSON, XML, or CSV data).

The example method also includes automatically issuing a response on the social media platform including at least a status of the event. In an example, the response (or later response) includes a resolution to the event. For example, the resolution may be automatically determined based on similarity to an earlier event. In an example, the social media analytics and response method includes identifying a resolution to the event. The response includes at least the resolution.

In an example, a complexity level of the event may be determined. The event may be escalated within the customer service. For example, the event may be escalated to a higher level of technical support within the customer service if the user posts that a first proposed solution did not address the issue.

A social media analytics and response system is also disclosed. An example system includes computer-readable instructions stored on a non-transient computer-readable medium. The computer-readable instructions executed by a processor to identify an event on a social media platform, interface with customer support after analyzing the event, and automatically issue a response on the social media platform.

A computer program product is also disclosed. An example computer program product includes computer-readable instructions stored on a non-transient computer-readable medium. The computer-readable instructions, when executed by a processor, include analyzing an event identified on a social media platform, reporting the event to customer support, and automatically issuing a response on the social media platform. In an example first stage, information is extracted from the event and the information is issued to customer support in one of a plurality of selectable data formats. In an example second stage, a status of the event is automatically returned to a user.

Before continuing, it is noted that as used herein, the terms “includes” and “including” mean, but are not limited to, “includes” or “including” and “includes at least” or “including at least.” The term “based on” means “based on” and “based at least in part on.”

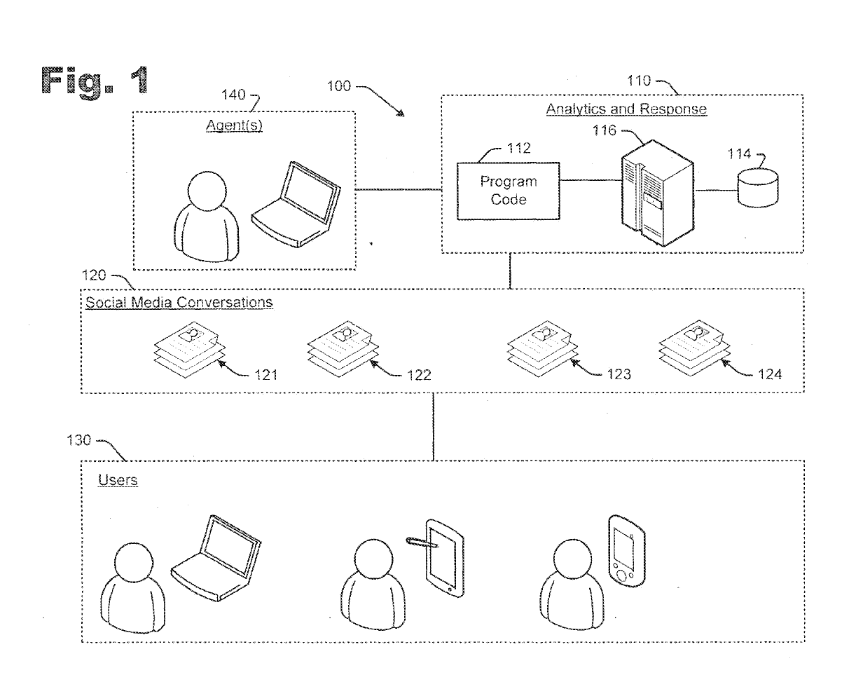

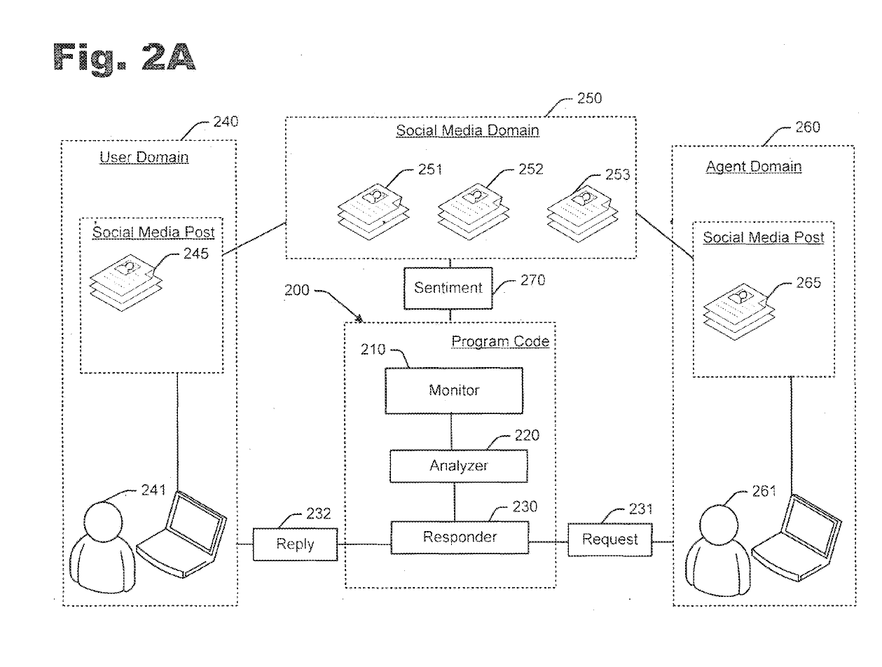

FIG. 1 is a high-level illustration of an example networked computer system 100 which may implement social media analytics and response. System 100 may be implemented with any of a wide variety of computing devices, such as, but not limited to, stand-alone desktop/laptop/netbook computers, workstations, server computers, blade servers, mobile devices, and appliances (e.g., devices dedicated to providing a service), to name a few examples. Each of the computing devices may include memory, storage, and a degree of data processing capability at least sufficient to manage a communications connection either directly with one another or indirectly (e.g., via a network). At least one of the computing devices is also configured with sufficient processing capability to execute the program code described herein.

In an example, the system 100 may implement analytics and response engine 110 via program code 112 stored on computer-readable storage 114 and executable by a processor at host 116. For purposes of illustration, the host 116 may be configured as a server computer. The analytics and response engine 110 may be instantiated via the program code 112, e.g., including associated application programming interfaces (APIs) and support infrastructure, as is commonly used in network-based applications (e.g., Internet-based and/or corporate intranet-based).

The analytics and response engine 110 enables monitoring of conversations 120 (e.g., customer feedback and reviews) posted on a network such as the Internet. In an example, the conversations 120 include discussion threads posted by users 130 to network sites 121-124 (e.g., social media sites or virtual rooms). By way of illustration, the conversations 120 may be posted to a user's personal “page” and/or to a company and/or product “page” set up within the social media network.

It is noted that discussions may be created by users in any online environment. For example, the user may start a new discussion. The user may also join an already started conversation, e.g., by replying to a post of another user. The user may also post a review and/or a comment on a product sales page, or elsewhere on the Internet (e.g., a site dedicated to providing customer reviews).

In an example, the analytics and response engine 110 may enable monitoring of conversations 120 by accessing a social media account of customer support agent(s) 140. For example, the customer support agent 140 may be assigned to handle all customer interaction based on a product or product line. The customer support agent 140 may have social media accounts for interacting with customers (or potential customers) on the most common or heavily trafficked social media sites. By monitoring the social media account of the customer support agent(s) 140, the analytics and response engine 110 receives data on directed conversations (i.e., those conversations related to a specific product or product line), thereby reducing the amount of data to be analyzed.

It is noted, however, that the analytics and response engine 110 may enable monitoring of conversations 120 by accessing the product page(s) and/or company page(s). The analytics and response engine 110 may also enable monitoring of conversations 120 by discovering online discussions (e.g., by hashtags) and/or by searching targeted sites (e.g., online review sites, forums) for conversations.

In an example, when a customer support agent 140 responds to a user post on a social media site, the analytics and response engine 110 triggers an event which pulls all data from the agent response. The term “event” refers to any predefined occurrence in the gathered data (e.g., in the social media conversations 120). For example, the predefined occurrence may be a negative customer review, a customer asking for technical support, a customer support agent responding to a social media post, etc. Example data which may trigger an event includes, but is not limited to, “Was it a Post or a Comment on a Post; a Tweet or Re-tweet?” (e.g., is this the first interaction with this user, or a follow-on?); “On What Post Agent Responded” (e.g., what is the User's Concern?); and “What was the Agent Response” (e.g., what is the support team's response?).

The analytics and response engine 110 may analyze a conversation to determine the complexity of user concern, whether a support ticket is to be generated, and/or whether the issue should be escalated within customer support (e.g., from a first level agent 140 to a higher level agent).

In an example, the analytics and response engine 110 may receive a response from the agent 140 (e.g., “A Support Ticket has been generated”). The analytics and response engine 110 may automatically generate a reply and post this reply to the conversation 120 (e.g., “Thanks Adam, a Support Ticket will be created for your concern”). In addition, the analytics and response engine 110 detects a predetermined text (e.g., a text string including “Support Ticket”), and automatically structures the derived data from the post and pushes this data to a customer relationship management (CRM) platform.

When the support team has addressed the issue, the CRM platform may push the resolution details to the analytics and response engine 110 (e.g., via Web Service, File Sharing, Http). The analytics and response engine 110 parses the ticket details and programmatically posts the resolution provided by the support team as a reply to the conversation.

In an example, the analytics and response engine 110 may automatically determine that a resolution already exists (e.g., if the issue has already been posed by other users 130 and resolved). As such, the analytics and response engine 110 may respond with a resolution or link to another post or site where the user can get answers to their issue without having to generate a support ticket.

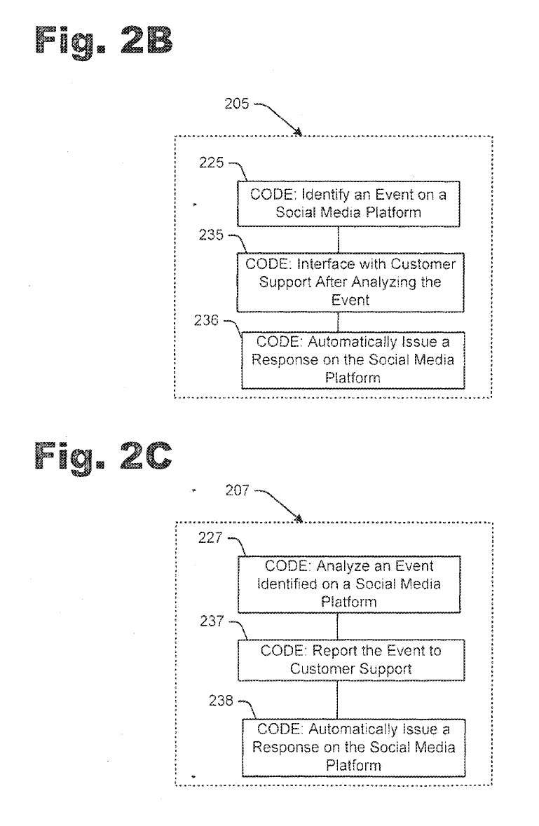

Program code used to implement features of the system can be better understood with reference to FIGS. 2A-C and the following discussion of various example functions. However, the operations described herein are not limited to any specific implementation with any particular type of program code.

FIGS. 2A-C show example architectures of computer-readable instructions illustrating social media analytics and response. In an example, the program code 112 discussed above with reference to FIG. 1 may be implemented in computer-readable instructions (such as, but not limited to, software or firmware). The computer-readable instructions may be stored on a non-transient computer-readable medium and are executable by one or more processors to perform the operations described herein. It is noted, however, that the components shown in FIGS. 2A-C are provided only for purposes of illustration of an example operating environment, and are not intended to limit implementation to any particular system.

The program code executes the function of the architecture of computer-readable instructions as self-contained modules. These modules can be integrated within a self-standing tool, or may run on top of an existing program code.

FIG. 2A illustrates an example of the architecture of computer-readable instructions 200, which may include a monitor module 210, an analyzer module 220, and a responder module 230.

In an example, the operating environment may be considered to include a user domain 240, a social media domain 250, and an agent domain 260. The architecture of computer-readable instructions 200 may operate across each of these domains. By way of illustration, a user 241 in the user domain 240 may access a social media site via an interface displayed in a network browser on the user's computing device. The user may make a post 245 to a new discussion thread and/or to an already existing discussion thread (e.g., by commenting). The discussion threads collectively form conversations 251-253 in the social media domain 250. The computer-readable instructions 200 may monitor conversations 251-253. In an example, the monitoring module 210 may monitor conversations 251-253 directly in the social media domain 250. In an example, the monitoring module 210 may monitor an agent's 261 social media account (e.g., posts 265) which also forms a part of the conversations 251-253 in the social media domain 250.

Posts 245 may be added directly by the user 241 and may include the user's sentiment (e.g., positive or negative). The user's sentiment may be contextual (e.g., “I like this product” or “This product is not working well”). In an example, sentiment 270 may be analyzed external to the program code 200 and provided as input to the program code 200. In another example, the analyzer module 220 may analyze the conversations 251-253 for this user sentiment. User sentiment and/or other information may be extracted from individual posts (e.g., user posts 245, agent posts 265) and/or the conversations 251-253. The information may include various parameters, and output based on this information may be generated based on any of a variety of criteria.

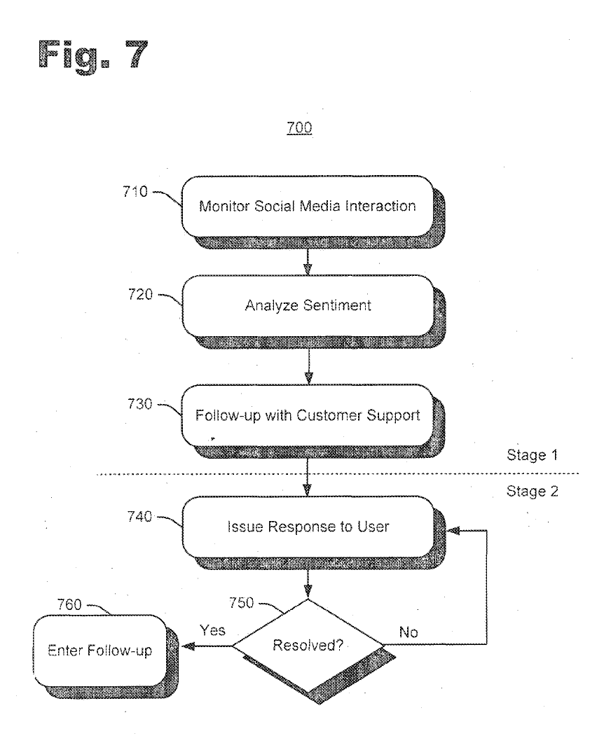

In an example, information garnered from the posts 245, 265 and/or conversations 251-253 is processed by the responder module 230. Responder module 230 may generate requests 231 to the agent domain 260 (e.g., requesting more information or that a ticket be generated). Other example requests 231 may include, but are not limited to, a request to expedite a matter (e.g., based on volume of a particular complaint), and a request to elevate a matter (e.g., to a higher level of technical support). In some examples, a response from responder module 230 may be based on a level of severity of the event which triggered the response, as discussed further below with respect to FIG. 7.

The responder module 230 may also issue a reply 232 to the user 241, e.g., via a reply post to the conversations 251-253 and/or directly to the user 241 (e.g., via email or tweet to the user). In an example, the reply 232 includes a status of the issue (e.g., support ticket has been generated). The reply 232 may also include a resolution. For example, the resolution may be based on a response to a support ticket from customer support in the agent domain 260. The resolution may also be automatic, e.g., based on a prior resolution to the same or similar issue without having generated a support ticket.

FIG. 2B illustrates an example architecture of computer-readable instructions 205. It is noted that instructions shown in FIG. 2B correspond to the modules in FIG. 2A. For example, instructions 225 correspond to the analyzer module 220, and instructions 235 and 236 correspond to the responder module 230.

In an example, instructions 225 may be executed to identify an event on a social media platform. Instructions 235 may be executed to interface with customer support after analyzing the event. Instructions 236 may be executed to automatically issue a response on the social media platform.

FIG. 2C illustrates an example architecture of computer-readable instructions 207. It is noted that instructions shown in FIG. 2C correspond to the modules in FIG. 2A. For example, instructions 227 correspond to the analyzer module 220, and instructions 237 and 238 correspond to the responder module 230.

In an example, instructions 227 may be executed to analyze an event identified on a social media platform. Instructions 237 may be executed to report the event to customer support. Instructions 238 may be executed to automatically issue a response on the social media platform.

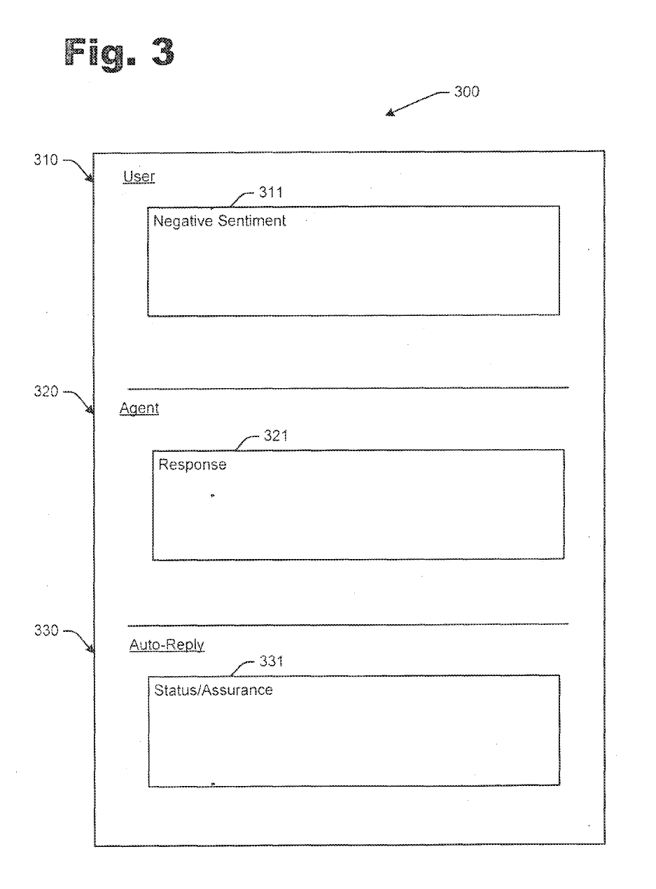

FIG. 3 illustrates interaction with a user in a social media interface 300 according to an example of social media analytics and response. Although the interface 300 may be implemented in any suitable environment, an example of a typical interface is a network browser interface displaying a social media site.

Conversations on the social media site may be accessed, for example, by scrolling through the list of posts and then clicking on a link for a related post. Of course, the interface 300 shown in FIG. 3 is only intended as an example and other interfaces for displaying and providing access to conversations are also contemplated.

The social media analytics and response engine may monitor the social media site for an event. In an example, the social media analytics and response engine monitors a product page or a company page. As such, the social media analytics and response engine may detect an event as a user 310 comment or post 311 to the page being monitored. In another example, the social media analytics and response engine monitors a social media account of an agent 320, and an event is detected based on an agent's response 321 to a user post 311.

In an example, the social media analytics and response engine may sort conversations to facilitate monitoring. Conversations within social media sites may be sorted by any suitable criteria. For example conversations may be sorted by agent, product, or product line. Conversations may also be sorted by hash tags. Conversations may also be sorted according to topic and/or other criteria. For example, conversations may be sorted based on recent activity to identify ‘freshness’ of discussions based on most recent conversations and those with no recent updates.

When an event is detected, the social media analytics and response engine may analyze the event for user sentiment. For example, the social media analytics and response engine may detect a post 311 including negative user sentiment, although events may be detected for positive or neutral user sentiment.

In an example, the content of a conversation may be parsed to extract the user sentiment and/or other information. Examples of other information that may be extracted include, but are not limited to, product, type of issue the user is having with the product, and a complexity level of the event. This data may be provided to customer support so that the event can be properly routed and handled by the appropriate agent. Information may be issued in any of a plurality of selectable data formats (e.g., as a JSON, XML, or CSV data object).

The social media analytics and response engine may further respond (e.g., via auto-reply 330) by a post 331 and/or directly to the user (e.g., via email or tweet to the user). The response may include a status and/or assurance that the user's issue is being worked on. If a resolution can be identified, the response may also include the resolution. For example, the resolution may be automatically determined based on similarity to an earlier event. Further responses may also be posted (e.g., after a resolution is found, or requesting additional information from the user in order for the agent to better understand the issue that the user is having).

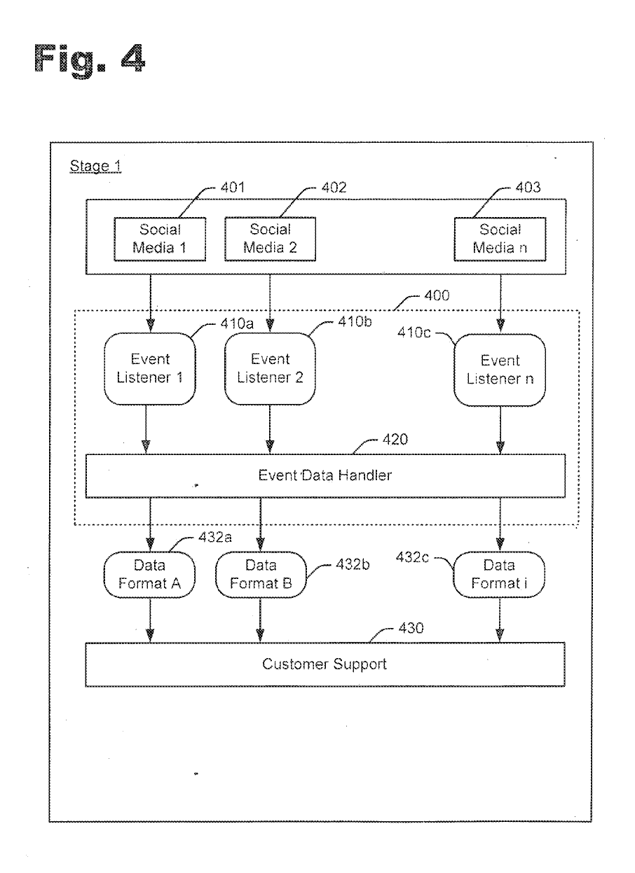

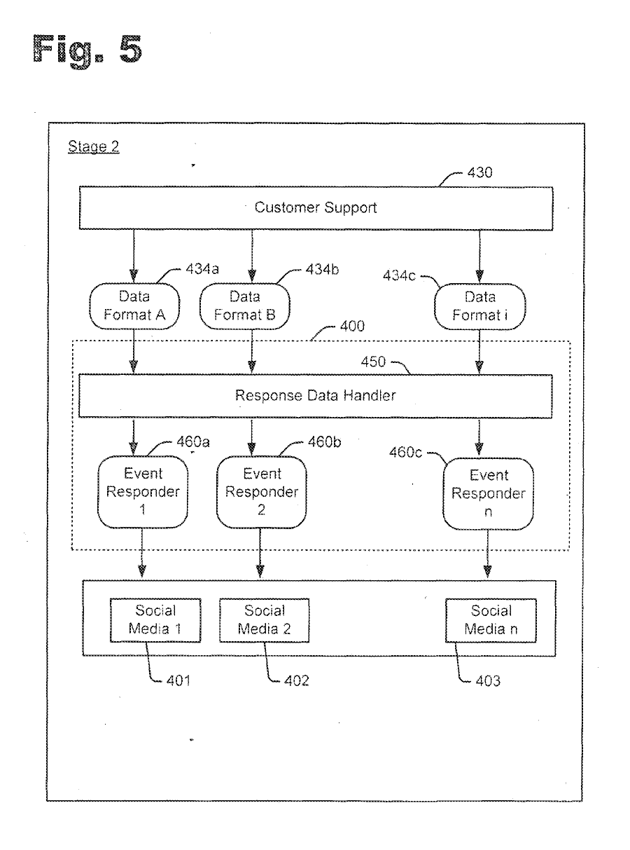

FIG. 4 is a process flow diagram illustrating an example Stage 1 social media analytics and response. FIG. 5 is a process flow diagram illustrating an example Stage 2 social media analytics and response. It is noted that the terms Stage 1 and Stage 2 are used only for purposes of illustration, and these terms are not intended to limit the teachings herein.

In an example, Stage 1 includes the social media analytics and response engine 400 monitoring interaction on one or more social media sites 401-403. The social media analytics and response engine 400 may monitor social media sites 401-403 with one or more event listeners 410a-c. Event listeners may be implemented as program code modules that execute on- or off-site from the social media site. For example, an off-site module may gather information from the social media site via download.

Monitoring social media interaction may include monitoring social media sites directly or indirectly. An example of direct monitoring includes monitoring a product page or a company page. Other examples of direct monitoring may include, but are not limited to, monitoring a discussion forum (e.g., for a class of products, such as “personal printing forum”), or an entire social media site. An example of indirect monitoring includes monitoring an agent's social media account (e.g., for posts responding to a user).

The social media analytics and response engine may analyze the social media interaction for user sentiment. User sentiment may be positive, neutral, or negative. In an example, negative sentiment indicates an issue that should be raised to customer service. However, positive and neutral sentiment may also include data that may be provided to a CRM system.

In an example, when negative sentiment is detected, this information, along with any other information gathered by an event data handler 420 of the social media analytics and response engine 400, may be issued to customer support 430. Information may be provided to customer support in any suitable format 432a-c (e.g., JSON, XML, or CSV data object). In an example, the issue may need a support ticket or to be elevated to another member of the customer support team.

In an example, Stage 2 includes the social media analytics and response engine 400 issuing a response to the user. The response may be provided by customer support 430 to the social media analytics and response engine 400, in any suitable format 434a-c (e.g., JSON, XML, or CSV data object). The response is processed by a response data handler 450, and issued to the social media sites 401-403, e.g., via event responders 460a-c.

The response may include at least a status of the issue (e.g., telling the user that a support ticket has been generated and to check back). The response may also include a resolution (e.g., based on the resolution to another similar or same issue). A response may be issued as a reply to a user's post on the social media site. In an example, the response may be issued directly to the user (e.g., via email or tweet to the user).

It is noted that Stage 1 and Stage 2 may commence further operations. For example, a determination may be made whether the issue has been resolved. The determination may be based on user feedback (e.g., the user posting that the product now works, or clicking a button in the post indicating that the issue has been resolved). If the issue has not yet been resolved, operations may continue until the issue is resolved, the user is no longer responding, or the issue otherwise becomes moot (e.g., the product or product line is no longer supported).

Before continuing, it should be noted that the examples described above are provided for purposes of illustration, and are not intended to be limiting. Other devices and/or device configurations may be utilized to carry out the operations described herein.

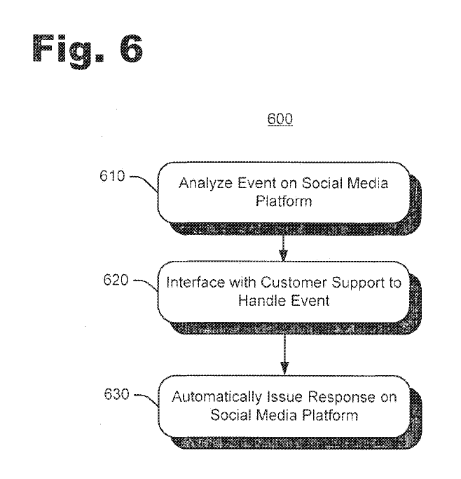

FIGS. 6-8 are flowcharts illustrating example operations which may be implemented for social media analytics and response. The operations may be embodied as logic instructions on one or more non-transient computer-readable media. When executed on a processor, the logic instructions cause a general purpose computing device to be programmed as a special-purpose machine that implements the described operations. In an example, the components and connections depicted in the figures may be used.

The operations may be implemented at least in part using an end-user interface (e.g., web-based interface). In an example, the user is able to make predetermined selections, and the operations described herein are implemented on a back-end device to present results to the user. The user can then make further selections.

Before continuing, it is noted that the operations shown and described herein are provided to illustrate example implementations. The operations are not limited to the ordering shown. Still other operations may also be implemented. It is also noted that various of the operations described herein may be automated or partially automated.

FIG. 6 is an example of operations 600 which may be implemented for social media analytics and response. Operation 610 includes analyzing an event on a social media platform. For example, analyzing the event may include extracting user sentiment from the event.

Operation 620 includes interfacing with customer support to handle the event. In an example, a parameter is extracted from the event, and issued to the customer support. For example, the parameter may include a complexity level of the event so that the event can be properly routed within customer support. The parameter may be issued in one of a plurality of selectable data formats (e.g., as a JSON, XML, or CSV data object).

Operation 630 includes automatically issuing a response on the social media platform, for example, including at least a status of the event. If a resolution can be identified, the response may also include the resolution. For example, the resolution may be automatically determined based on similarity to an earlier event.

FIG. 7 illustrates example stages of operations 700 which may be implemented for social media analytics and response. In an example, operations 710-730 may be considered Stage 1 response, and operations 740-760 may be considered Stage 2 response.

Operation 710 includes monitoring social media interaction. Monitoring social media interaction may include monitoring social media sites directly or indirectly. An example of direct monitoring includes monitoring a product page or a company page. Other examples of direct monitoring may include, but are not limited to, monitoring a discussion forum (e.g., for a class of products, such as “personal printing forum”), or an entire social media site. An example of indirect monitoring includes monitoring an agent's social media account (e.g., for posts responding to a user).

Operation 720 includes analyzing the social media interaction for user sentiment. User sentiment may be positive, neutral, or negative. In an example, negative sentiment indicates an issue that should be raised to customer service. However, positive and neutral sentiment may also include data that may be provided to a CRM system.

Operation 730 includes follow-up with customer support. In an example, when negative sentiment is detected the issue may need a support ticket or to be elevated to another member of the customer support team.

Operation 740 includes issuing a response to the user. A response may be issued as a reply to a user's post on the social media site. In an example, the response may be issued directly to the user (e.g., via email or tweet to the user). The response may include at least a status of the issue (e.g., telling the user that a support ticket has been generated and to check back). The response may also include a resolution (e.g., based on the resolution to another similar or same issue).

In an example, the response is based on a level of severity of the event which triggered the response. By way of illustration, if a customer is complaining about the color of a product, the response may be forwarded to a customer service representative to respond that “other colors will be available in future releases.” However, if a customer is complaining that the device overheats after several hours of usage, this concern may be forwarded to a technician having a high-level of expertise with the cooling system. The different levels of response are warranted because addressing cooling issues that could potentially result in a fire is more severe (i.e., has safety consequences) than the color of the product (which is merely a matter of consumer preference).

At operation 750, a determination is made whether the issue has been resolved. The determination may be based on user feedback (e.g., the user posting that the product now works, or clicking a button in the post indicating that the issue has been resolved). If the issue has not yet been resolved, the process flow may return to operation 730 and/or 740. In an example, the event may be escalated within customer service. For example, if the event is a technical issue with a product, and the first-level responders within customer service are unable to resolve the issue (e.g., by resetting the device), the event may be escalated to a customer support representative having a more in-depth technical understanding to assist the customer to find a resolution (e.g., via a firmware upgrade).

If the issue has been resolved, then in operation 760 a follow-up phase may be entered.

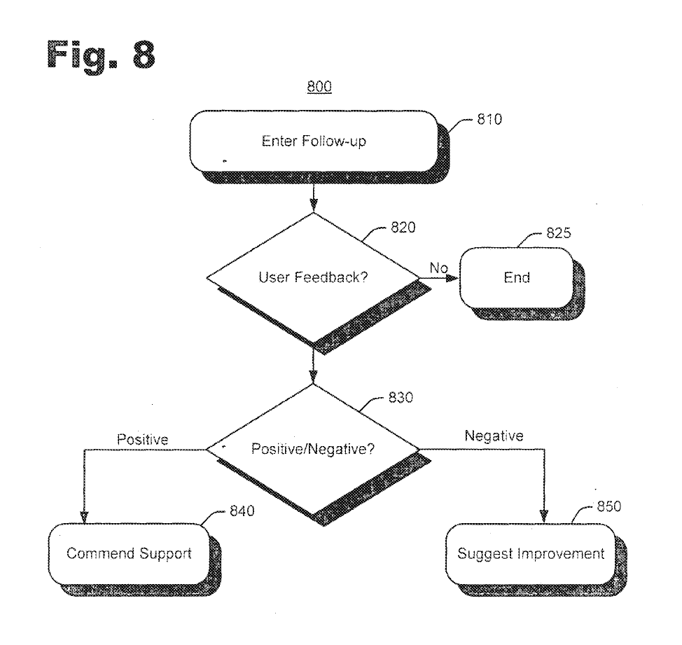

FIG. 8 illustrates example follow-up operations 800 for social media analytics and response. In an example, the follow-up operations continue from operation 760 in FIG. 7, wherein the issue has been resolved, but additional follow-up 810 may result in a more satisfied customer and/or additional data may be provided to the customer support team for handling future issues.

Operation 820 includes making a determination whether the user has provided any further feedback. If no further feedback is found, then operations may end at 825. In some cases, however, the user may issue feedback. For example, the user may post a reply saying that he or she is satisfied with the response, or conversely, that he or she believes the response took too long or did not fully address the issue.

Operation 830 includes assessing whether the feedback is positive or negative. Positive feedback may be used by the CRM, for example to provide commendations 840 to the agent and/or customer support team. Negative feedback may be used by the CRM, for example to suggest improvements that may be made to handle support requests in the future.

It is noted that the examples shown and described are provided for purposes of illustration and are not intended to be limiting. Still other examples are also contemplated.

1. A social media analytics and response method, comprising:
analyzing an event on a social media platform;
interfacing with customer support to handle the event; and
automatically issuing a response on the social media platform including at least a status of the event.

2. The method of claim 1, wherein analyzing the event further comprises extracting user sentiment from the event.

3. The method of claim 1, further comprising identifying a resolution to the event, the response including at least the resolution.

4. The method of claim 1, further comprising extracting at least one parameter from the event, and issuing the at least one parameter to the customer support.

5. The method of claim 4, further comprising issuing the at least one parameter to the customer support in one of a plurality of selectable data formats.

6. The method of claim 1, further comprising extracting a complexity level of the event.

7. The method of claim 1, wherein the response includes at least a resolution to the event, the resolution automatically determined based on similarity to an earlier event.

8. The method of claim 1, further comprising escalating the event within the customer service.

9. A social media analytics and response system comprising computer-readable instructions stored on a non-transient computer-readable medium, the computer-readable instructions executed by a processor to:
identify an event on a social media platform;
interface with customer support after analyzing the event; and
automatically issue a response on the social media platform.

10. The system of claim 9, wherein the response is based on a level of severity of the event.

11. The system of claim 9, wherein, the response includes at least a status of the event.

12. The system of claim 9, wherein the computer-readable instructions are further executed by the processor to:
in a first stage, issue the event to customer support; and
in a second stage, issue a status of handling the event to a user.

13. The system of claim 9, wherein the computer-readable instructions are further executed by the processor to:
extracting information from the event; and
issue the information to the customer support in one of a plurality of selectable data formats.

14. A social media analytics and response computer program product having computer-readable instructions stored on a non-transient computer-readable medium, the computer-readable instructions when executed by a processor comprising:
analyzing an event identified on a social media platform;
reporting the event to customer support; and
automatically issuing a response on the social media platform.

15. The computer program product of claim 14, wherein the computer-readable instructions when executed by a processor further comprises.
in a first stage, extracting information from the event and issuing the information to the customer support in one of a plurality of selectable data formats issue the event to customer support; and
in a second stage, automatically returning a status of the event to a user.
